(19) United States
(12) Patent Application Publication
(10) Pub. No.: US 2026/0097406 A1
(43) Pub. Date: Apr. 9, 2026

(54) FLUID NOZZLE AND FLUID SYSTEM

(71) Applicant: 3M INNOVATIVE PROPERTIES COMPANY, St. Paul, MN (US)

(72) Inventors: Scott D. Gullicks, River Falls, WI (US); Ryan P. Marrinan, Lino Lakes, MN (US)

(21) Appl. No.: 19/114,377

(22) PCT Filed: Sep. 22, 2023
(86) PCT No.: PCT/IB2023/059415

§ 371 Date: Mar. 21, 2025

Related U.S. Application Data
(60) Provisional application No. 63/376,893, filed on Sep. 23, 2022.

(51) Int. Cl. B05B 1/04

(52) U.S. Cl. CPC B05B 1/044

(57) ABSTRACT

This disclosure relates to a fluid nozzle comprising a body with an outlet and an inlet at each end, connected by a fluid passageway. The outlet has a maximum width greater than the maximum inlet width and is disposed at the first end of the longitudinal axis. The body tapers outwardly in a flow direction from the second end to the first end. This tapering is formed by a pair of opposing sidewalls that extend from the second end to the first end. Each of the sidewalls comprises a plurality of first wall portions and a plurality of second wall portions that are inclined to an adjacent wall portion. The second wall portions extend outwardly relative to the longitudinal axis in the flow direction and are inclined to the longitudinal axis by an inclination angle.

### TECHNICAL FIELD

The present disclosure generally relates to a fluid system, and in particular, relates to a fluid nozzle for a fluid system.

### BACKGROUND

Vehicles, such as automobiles, typically include multiple external panels that are connected to a frame or a chassis. One or more gaps present between such panels may be filled with a seam sealer to prevent moisture, dirt, and the like from passing through the gaps and into an engine or passenger compartment of the vehicle. Such seam sealers can also provide sound damping to the vehicle. When one or more of these panels need to be replaced, the gaps between the panels are resealed by a technician. Oftentimes, seam seals have a unique look or pattern that is associated with the original manufacturer of the vehicle. When replacing these seam seals, the technician may desire to replicate the look or pattern of the original seam seal.

The ability to replicate an original equipment manufacturer (OEM) applied seam seal may require the use of a spray applicator and materials that work in, or with, a particular type of the spray applicator. This phenomenon may require multiple spray applicators, fluid nozzles, and materials. Spray applicators are typically expensive and may be difficult to clean. Moreover, additional applicators may be needed to brush some material prior to applying a sprayed texture, or a bead pattern.

Conventionally, a dual cartridge system used for spraying a fluid mixture containing two fluid components includes a dual barrel cartridge unit or other source (e.g., five gallon pails, five fifty-five gallon drums) containing the two fluid component, a disposable static mixer which is connected to a fluid nozzle, and an air manifold which is connected to a supply of pressurized air. Alternatively, a single cartridge system used for spraying a single fluid component generally includes a single barrel cartridge unit or other source containing the single fluid component, a fluid nozzle connected to the single barrel cartridge unit, and an air manifold which is connected to a supply of pressurized air. Typically, for single cartridge systems, the static mixer is integral with the fluid nozzle. Hence, such fluid nozzles may not be usable with dual cartridge systems. Overall, fluid nozzles usable with dual cartridge systems are different in design from fluid nozzles usable with single cartridge systems, thereby increasing part numbers.

Currently, seam sealing applications require purchasing of separate fluid nozzles based on a type of application (such as, single cartridge systems and dual cartridge systems), which may lead to confusion and incorrect ordering, and may also lead to longer wait times for completing repairs.

Joints and gaps are typically filled with high viscosity fluids (e.g., using a sealer) for protection against leaks of water, air, etc. For example, gaps between various external panels (e.g., hemmed flanged panels) of a vehicle may be filled with a seam sealer to prevent moisture, dirt, etc., from passing through the gaps. In downstream repair or aftermarket applications, the gaps between such panels may need to be resealed by a technician. However, technicians have a difficult time replicating, or matching, the quality of sealing originally produced through expensive machinery that are programmed to have precise specifications for pressure, flow, volume, temperature, timing, positioning, viscosity, etc.

Possibility for human error (e.g., uneven bead height, width, or uniformity) in the field or in a repair shop increases especially with inexperienced technicians. Implementation often falls short of original equipment manufacturers capabilities, and this mismatch may be easily observed, such as in a repair assessment or insurance context. Therefore, there is a need for improved techniques to reproduce sealing that do not add time or material costs to repair or aftermarket restoration practices.

Current sealant applicators are non-rotatable, i.e., have inconsistent cross-section of an outlet of the sealant applicator with change in an orientation of the sealant applicator. Further, the current sealant applicators may not allow a user to hold the sealant applicator comfortably while applying the sealant and adjust for the numerous contours and shapes of the panels on which the sealant is being applied to. Vehicles, such as automobiles typically include multiple external panels that are connected to a frame or chassis. Gaps between these panels can be filled with a seam sealer to prevent moisture, dirt, etc., from passing through the gaps and into engine and/or passenger compartments of the vehicle. In some cases, such seam sealers may also provide sound damping to the vehicle. When one or more of the panels need to be replaced, the gaps between such panels may be resealed by a user. Furthermore, when replacing the seam seals, the user may desire to replicate a look or pattern of original seam seals.

There are a variety of seam sealers available that have different compositions and viscosities. Conventional fluid nozzles may not be suitable for use with the different seam sealers. That is, conventional fluid nozzles may be specifically designed and suitable for use with a single seam sealer product. Further, conventional fluid nozzles may be unable to replicate a look or pattern of original seam seals when not used with the seam sealer that they are specifically designed for.

Therefore, there is a need for a fluid nozzle that is suitable for use with a variety of different seam sealers having different viscosities. Further, there is a need for a fluid nozzle that is able to replicate a look or pattern of original seam seals regardless of a difference in viscosities of different seam sealers.

Joints and gaps are typically filled with a seam sealer for sealings against leaks (e.g., of water, air, etc.). For example, gaps between various external panels (e.g., hemmed flanged panels) of a vehicle may be filled with the seam sealer to prevent moisture, dirt, etc., from passing through the gaps. In downstream repair or aftermarket applications, the gaps between such panels may be resealed by a technician. However, the technicians may have difficulty replicating or matching the quality of an original sealing.

In some cases, there may be a requirement of a wide and/or flat application of a material of the seam sealer to replicate the original sealing having a wide and/or flat appearance. In such applications, tooling or brushing of the applied material in order to achieve the wide and/or flat appearance may lead to air entrapment or contamination prior to curing of the seam sealer. This may also negatively impact paint application at a later point.

### SUMMARY

In a first aspect, the present disclosure provides a fluid nozzle including a body. The body includes a first end and a second end opposite to the first end. The body extends along a longitudinal axis defined between the first end and the second end. The body includes an outlet disposed at the first end. The outlet has a maximum outlet width orthogonal to the longitudinal axis at the first end. The body further includes an inlet disposed at the second end. The inlet has a maximum inlet width orthogonal to the longitudinal axis at the second end. The maximum outlet width is greater than the maximum inlet width. The body further includes a fluid passageway disposed within the body and extending from the inlet to the outlet. The body further includes a pair of sidewalls opposing each other and extending at least along the longitudinal axis from the second end to the first end. Each of the pair of sidewalls includes a plurality of first wall portions and a plurality of second wall portions alternating with each other. Each first wall portion from the plurality of first wall portions is inclined to an adjacent second wall portion from the plurality of second wall portions. Further, each of the plurality of second wall portions extends outwardly relative to the longitudinal axis in a flow direction from the second end to the first end, such that the body tapers outwardly in the flow direction. Each of the plurality of first wall portions extends parallel to the longitudinal axis. Each of the plurality of second wall portions is inclined to the longitudinal axis by an inclination angle. The pair of sidewalls at least partially defines the fluid passageway therebetween.

In a second aspect, the present disclosure provides a method of using the fluid nozzle of the first aspect. The method includes connecting the fluid nozzle to a fluid source. The method further includes directing a fluid from the fluid source into the inlet of the fluid nozzle. The method further includes ejecting the fluid through the outlet of the fluid nozzle.

In a third aspect, the present disclosure provides a fluid system including a fluid nozzle and a fluid source. The method includes connecting the fluid nozzle to the fluid source. The fluid nozzle includes a body. The body includes a first end and a second end opposite to the first end. The body extends along a longitudinal axis defined between the first end and the second end. The body includes an outlet disposed at the first end. The outlet has a maximum outlet width orthogonal to the longitudinal axis at the first end. The body further includes an inlet disposed at the second end. The inlet has a maximum inlet width orthogonal to the longitudinal axis at the second end. The maximum outlet width is greater than the maximum inlet width. The body further includes a fluid passageway disposed within the body and extending from the inlet to the outlet. The body further includes a pair of sidewalls opposing each other and extending at least along the longitudinal axis from the second end to the first end. Each of the pair of sidewalls includes a plurality of first wall portions and a plurality of second wall portions alternating with each other. Each first wall portion from the plurality of first wall portions is inclined to an adjacent second wall portion from the plurality of second wall portions. Further, each of the plurality of second wall portions extends outwardly relative to the longitudinal axis in a flow direction from the second end to the first end, such that the body tapers outwardly in the flow direction. Each of the plurality of first wall portions extends parallel to the longitudinal axis. Each of the plurality of second wall portions is inclined to the longitudinal axis by an inclination angle. The pair of sidewalls at least partially defines the fluid passageway therebetween. The fluid source is connected with the fluid nozzle and disposed in fluid communication with the fluid passageway.

The details of one or more examples of the disclosure are set forth in the accompanying drawings and the description below. Other features, objects, and advantages of the disclosure will be apparent from the description and drawings, and from the claims.

### BRIEF DESCRIPTION OF THE DRAWINGS

Exemplary embodiments disclosed herein may be more completely understood in consideration of the following detailed description in connection with the following figures. The figures are not necessarily drawn to scale. Like numbers used in the figures refer to like components. However, it will be understood that the use of a number to refer to a component in a given figure is not intended to limit the component in another figure labeled with the same number.

FIG. 1 is a schematic perspective view of a fluid system including a fluid nozzle and a fluid source connected with the fluid nozzle, according to an embodiment of the present disclosure;

FIG. 2 is a schematic sectional view of the fluid nozzle, according to an embodiment of the present disclosure;

FIG. 3A is a schematic top view of the fluid nozzle, according to an embodiment of the present disclosure;

FIG. 3B is a schematic bottom view of the fluid nozzle, according to an embodiment of the present disclosure;

FIG. 4 is a schematic front view of the fluid nozzle, according to an embodiment of the present disclosure;

FIG. 5 is a schematic side view of the fluid nozzle, according to an embodiment of the present disclosure;

FIG. 6 is a schematic top view of a fluid nozzle, according to another embodiment of the present disclosure; and

FIG. 7 is a flowchart for a method of using the fluid nozzle, according to an embodiment of the present disclosure.

### DETAILED DESCRIPTION

In the following description, reference is made to the accompanying figures that form a part thereof and in which various embodiments are shown by way of illustration. It is to be understood that other embodiments are contemplated and may be made without departing from the scope or spirit of the present disclosure. The following detailed description, therefore, is not to be taken in a limiting sense.

In the following disclosure, the following definitions are adopted.

As used herein, all numbers should be considered modified by the term “about”. As used herein, “a,” “an,” “the,” “at least one,” and “one or more” are used interchangeably.

The term “about”, unless otherwise specifically defined, means to a high degree of approximation (e.g., within +/−5% for quantifiable properties) but again without requiring absolute precision or a perfect match.

As used herein as a modifier to a property or attribute, the term “generally” or “typically”, unless otherwise specifically defined, means that the property or attribute would be readily recognizable by a person of ordinary skill but without requiring absolute precision or a perfect match (e.g., within +/−20% for quantifiable properties).

The term “substantially”, unless otherwise specifically defined, means to a high degree of approximation (e.g., within +/−10% for quantifiable properties) but again without requiring absolute precision or a perfect match.

Terms such as same, equal, uniform, constant, strictly, and the like, are understood to be within the usual tolerances or measuring error applicable to the particular circumstance rather than requiring absolute precision or a perfect match.

As used herein, the terms “first” and “second” are used as identifiers. Therefore, such terms should not be construed as limiting of this disclosure. The terms “first” and “second” when used in conjunction with a feature or an element can be interchanged throughout the embodiments of this disclosure.

As used herein, when a first material is termed as “similar” to a second material, at least 90 weight % of the first and second materials are identical and any variation between the first and second materials includes less than about 10 weight % of each of the first and second materials.

As used herein, “at least one of A and B” should be understood to mean “only A, only B, or both A and B”.

As used herein, the recitations of numerical ranges by endpoints include all numbers subsumed within that range as well as the endpoints (e.g., 1 to 5 includes 1, 1.5, 2, 2.75, 3, 3.80, 4, 5, etc.).

The term “coupled” or “connected” may include direct physical connections between two or more components, or indirect physical connections between two or more components that are connected together by one or more additional components. For example, a first component may be coupled to a second component by being directly connected together or by being connected by a third component.

Unless specified or limited otherwise, the terms “attached,” “connected,” “coupled,” and variations thereof, are used broadly and encompass both direct and indirect attachments, connections, and couplings.

As used herein, the term “configured to” and like is at least as restrictive as the term “adapted to” and requires actual design intention to perform the specified function rather than mere physical capability of performing such a function.

As used herein, the term “resilient deformation” refers to an elastic deformation of a component or a portion of the component upon application of a force. The component, when resiliently deformed, may have a deformed state. The component may not plastically deform in the deformed state. The component may return to its undeformed state upon removal of the force. The force may be applied by another component. An extent of the elastic deformation may depend upon a magnitude of the force applied.

In general, the present disclosure provides various embodiments of a fluid nozzle and a fluid system that includes the fluid nozzle. The fluid nozzle can include a tube and a manifold disposed around tube. Typically, original equipment manufacturer (OEM) seam-sealing techniques require time-consuming manual processes to provide seam seals that resemble original factory-applied seam seals. Such processes include using hand tools to physically create specific textures and patterns by manually changing the appearance. Further, such processes include the use of combs, modified plastic body filler spreaders, Scotch Brite™ scuff pads, or other tooling after dispensing sealer onto the surface; physically altering the dispensing through movements of the applicator, adjustment of air pressure using a trigger of a pneumatic applicator, or application of physical pressure of a manual applicator. Other techniques can also include, but are not limited to, cutting or manipulating the dispensing nozzles or selection of various sealing materials being utilized.

Conventionally, a dual cartridge system used for spraying a fluid mixture containing two fluid components includes a dual barrel cartridge unit or other source (e.g., five gallon pails, five fifty-five gallon drums) containing the two fluid component, a disposable static mixer which is connected to a fluid nozzle, and an air manifold which is connected to a supply of pressurized air. Alternatively, a single cartridge system used for spraying a single fluid component generally includes a single barrel cartridge unit or other source containing the single fluid component, a fluid nozzle connected to the single barrel cartridge unit, and an air manifold which is connected to a supply of pressurized air. Typically, for single cartridge systems, the static mixer is integral with the fluid nozzle. Hence, such fluid nozzles may not be usable with dual cartridge systems. Overall, fluid nozzles usable with dual cartridge systems are different in design from fluid nozzles usable with single cartridge systems, thereby increasing part numbers. Currently, seam sealing applications require purchasing of separate fluid nozzles based on a type of application (such as, single cartridge systems and dual cartridge systems), and may lead to confusion and incorrect ordering as well as longer wait times for completing repairs.

Therefore, there exists a need for a fluid nozzle that may be interchangeably connected to single cartridge systems as well as dual cartridge systems, thereby reducing part numbers and increasing efficiency of fluid systems that include fluid nozzles.

The present disclosure provides a fluid nozzle. The fluid nozzle includes a tube including a first tube end and a second tube end opposite to the first tube end. The tube extends along a tube axis defined between the first tube end and the second tube end. The tube includes an inlet defined at the first tube end. The tube includes an outlet defined at the second tube end. The tube further includes a fluid passageway disposed within the tube and extending from the inlet to the outlet. The tube further includes a first portion including the outlet. The first portion extends from the second tube end towards the first tube end along the tube axis. The first portion at least partially defines the fluid passageway therein. The tube further includes a second portion including the inlet. The second portion extends from the first portion to the first tube end along the tube axis. The second portion at least partially defines the fluid passageway therein. The second portion is configured to be selectively and removably connected to a first fluid source. The tube further includes a third portion extending from the first tube end towards the second tube end along the tube axis. The third portion at least partially surrounds and is connected to the second portion. The third portion includes a cylindrical section extending along a length of the third portion and at least one first coupling element disposed on the cylindrical section. The fluid nozzle further includes an adapter configured to be selectively and removably connected to the third portion of the tube when the first fluid source is disconnected from the second portion of the tube. The adapter defines an adapter channel that is in fluid communication with the fluid passageway when the adapter is connected to the third portion of the tube. The adapter is configured to be detachably connected to a second fluid source different from the first fluid source. The adapter includes a first adapter end, a second adapter end opposite to the first adapter end, an adapter axis extending between the first adapter end and the second adapter end, an inner surface, and an outer surface. The adapter is configured to at least partially receive the third portion of the tube therein through the first adapter end. The adapter includes at least one second coupling element disposed on the inner surface proximal to the first adapter end and extending angularly about the adapter axis. The at least one second coupling element is configured to at least partially receive the at least one first coupling element of the third portion therein to form a snap-fit connection between the adapter and the third portion. The tube is rotatable relative to the adapter about the tube axis upon connection with the adapter.

The fluid nozzle of the present disclosure may be used for dispensing high viscosity materials. The fluid nozzle as described herein may be interchangeably used with single cartridge systems and dual cartridge systems. More particularly, the present disclosure provides a modular fluid nozzle that may be quickly and easily connected to a mixer by a press-fit. The mixer may be in turn connected to a dual barrel cartridge unit. Alternatively, the modular fluid nozzle may be quickly and easily connected to the adapter by a snap-fit. Further, the adapter may be threadedly connected to a single barrel cartridge unit. As the modular fluid nozzle may be connected with two types of fluid systems, costs associated with handling and manufacturing of fluid nozzles with different part numbers may be eliminated. Further, the fluid nozzle may be disposable, thereby eliminating time required for cleaning and additional costs associated with cleaning solutions. Moreover, the fluid nozzle may be connectable with different designs of air manifolds and nozzle spray tips.

Further, the fluid nozzle of the present disclosure may reduce the number of applicators (and more specifically, fluid nozzles) that may be required to perform seam sealing applications to replicate OEM look and appearance, while increasing application efficiency, reducing waste, and creating a unique, no clean up solution for both single cartridge systems and dual cartridge systems.

Generally, a seam sealer is used for sealings joints and gaps against leaks (e.g., of water, air, etc.). For example, gaps between various external panels (e.g., rear body panels, trunk floor panels, passenger compartment floor panels, frame rails, roof channel/roof ditch, etc.) of a vehicle may be filled with the seam sealer to prevent moisture, dirt, etc. from passing through the gaps. In downstream repair or aftermarket applications, the gaps between such panels may be resealed by a technician. In some cases, the seam sealers have a unique look or pattern that is associated with the original manufacturer of the vehicle. Therefore, when replacing these seam sealers, the technician may try to replicate a look or match a quality of an original seam sealing. However, the technician may have difficulty in replicating the look or matching the quality of the original seam sealing.

In some cases, there may be a requirement of a wide and/or flat application of a material of the seam sealer to replicate the original seam sealing having a wide and/or flat appearance. In such applications, tooling or brushing of the applied material in order to achieve the wide and/or flat appearance may lead to air entrapment or contamination prior to curing of the seam sealer. This may also negatively impact paint application at a later point.

Typically, application of a material of the seam sealer is based on an outlet shape and size of a nozzle designed for dispensing the material of the seam sealer. Further, in some cases, the material of the seam sealer may be a high viscosity fluid. Some conventional nozzles have an outlet having a wide and/or flat shape for the wide and/or flat application of the material of the seam sealer. Such conventional nozzles typically have angled sidewalls defining an angled passageway for the fluid. The angled passageway defined by the angled sidewalls path may result in the fluid continuing to flow along a same angle as that of the angled sidewalls. Thus, the fluid may extend beyond a desired width by considerable distances due to the angled sidewalls of the conventional nozzles. Therefore, such conventional nozzles may not provide a controlled application of the fluid/material of the seam sealer. Specifically, the conventional nozzles may not provide the desired width of the material. Therefore, the technicians may face difficulties to replicate or match the original seam sealing.

Thus, there exists a need for a fluid nozzle that may provide a greater control over the application of the material of the seam sealer, so that the technicians may be able to replicate or match the original seam sealing with ease.

According to aspects of this disclosure, a fluid nozzle includes a body including a first end and a second end opposite to the first end. The body extends along a longitudinal axis defined between the first end and the second end. The body includes an outlet disposed at the first end. The outlet has a maximum outlet width orthogonal to the longitudinal axis at the first end. The body further includes an inlet disposed at the second end. The inlet has a maximum inlet width orthogonal to the longitudinal axis at the second end. The maximum outlet width is greater than the maximum inlet width. The body further includes a fluid passageway disposed within the body and extending from the inlet to the outlet. The body further includes a pair of sidewalls opposing each other and extending at least along the longitudinal axis from the second end to the first end. Each of the pair of sidewalls includes a plurality of first wall portions and a plurality of second wall portions alternating with each other. Each first wall portion from the plurality of first wall portions is inclined to an adjacent second wall portion from the plurality of second wall portions. Further, each of the plurality of second wall portions extends outwardly relative to the longitudinal axis in a flow direction from the second end to the first end, such that the body tapers outwardly in the flow direction. Each of the plurality of first wall portions extends parallel to the longitudinal axis. Each of the plurality of second wall portions is inclined to the longitudinal axis by an inclination angle. The pair of sidewalls at least partially defines the fluid passageway therebetween.

Since each of the plurality of first wall portions extends parallel to the longitudinal axis and each of the plurality of second wall portions is inclined to the longitudinal axis by an inclination angle, the plurality of first wall portions and the plurality of second wall portions alternating with each other may allow a fluid flowing through the fluid passageway more time to extrude at a desired width. In other words, the plurality of first wall portions and the plurality of second wall portions alternating with each other may reduce a rate of flow of the fluid so that the fluid nozzle may provide a controlled flow of the fluid in the flow direction to achieve a desired width of the fluid and prevent extending of the fluid beyond the desired width. The plurality of first wall portions and the plurality of second wall portions of the fluid nozzle may further constrain the fluid to the desired width defined between the pair of sidewalls to provide the controlled flow of the fluid in the flow direction. Therefore, the fluid may not extend beyond the desired width by considerable distances.

The fluid nozzle of the present disclosure providing the controlled flow of the fluid in the flow direction may therefore provide a controlled application of the fluid (e.g., the seam sealer) on gaps/joints to achieve a desired appearance (e.g., having the desired width). Specifically, the fluid nozzle may ensure that the fluid extrudes having the desired width on the gaps/joints to achieve the desired appearance. Therefore, the technicians may have greater a control over a final appearance of the extruded fluid and an increased ability to replicate or accurately match the original seam sealing. Further, tooling or brushing of the applied material in order to achieve the wide and/or flat appearance may not be required with may otherwise lead to air entrapment or contamination prior to curing of the seam sealer and/or negatively impact paint application at a later point.

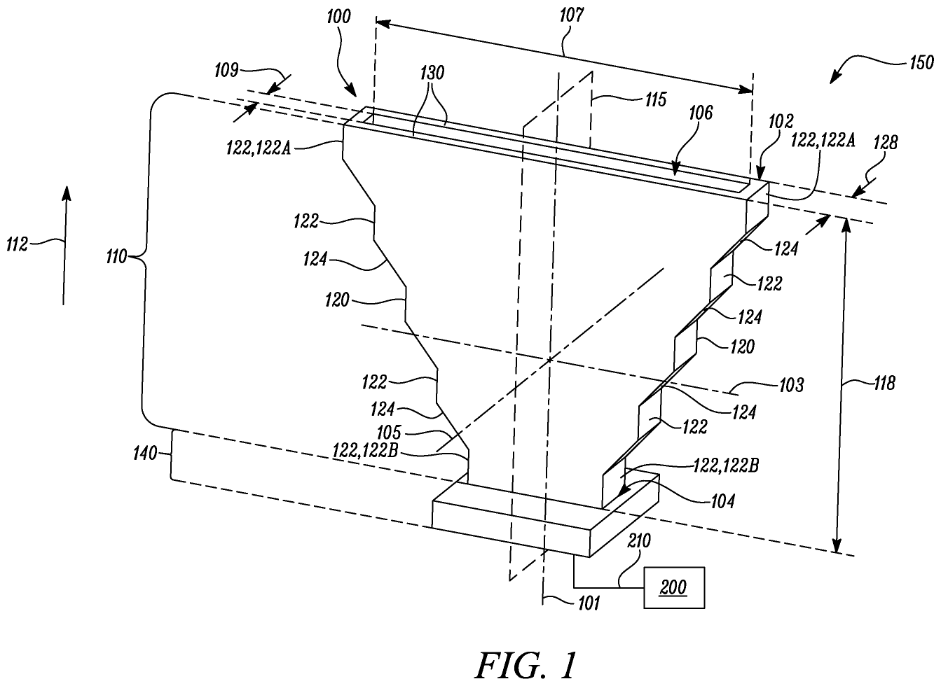

FIG. 1 illustrates a schematic perspective view of a fluid system 150, according to an embodiment of the present disclosure. The fluid system 150 includes a fluid nozzle 100. The fluid system 150 further includes a fluid source 200 connected with the fluid nozzle 100. In some embodiments, the fluid system 150 may include a fluid line 210 to connect the fluid source 200 to the fluid nozzle 100. In some examples, the fluid nozzle 100 may dispense or extrude a fluid received from the fluid source 200.

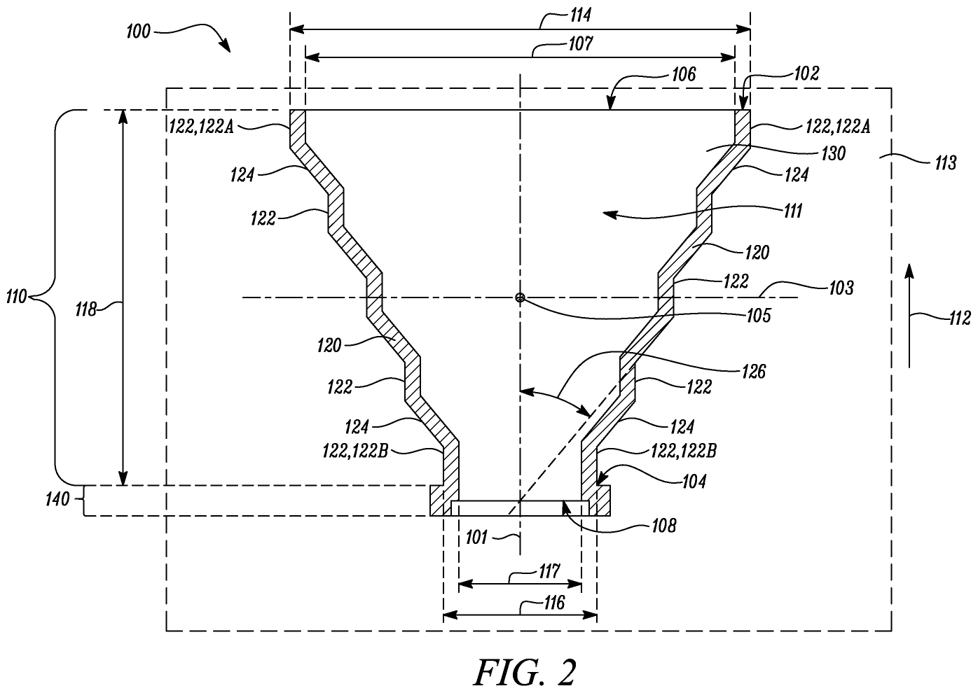

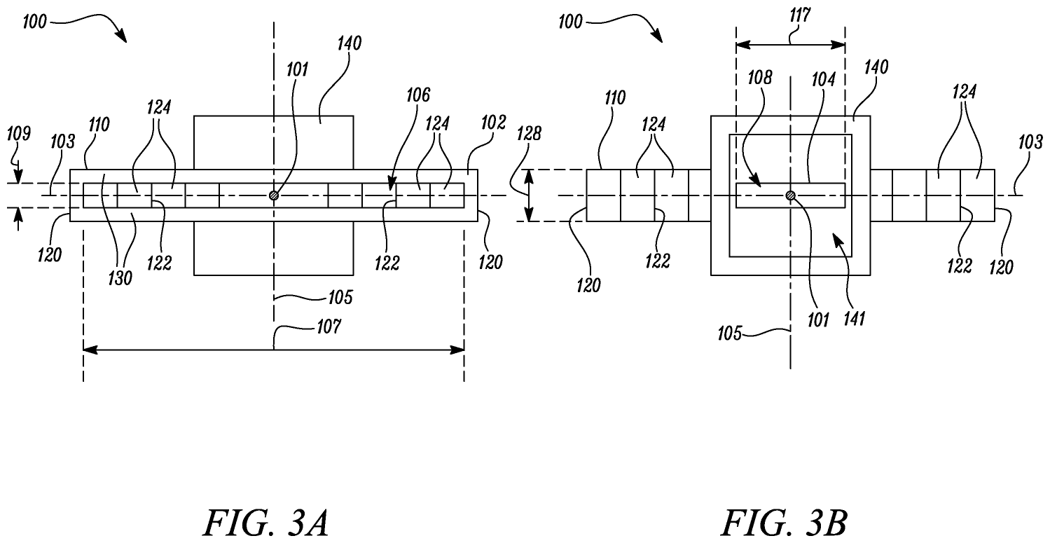

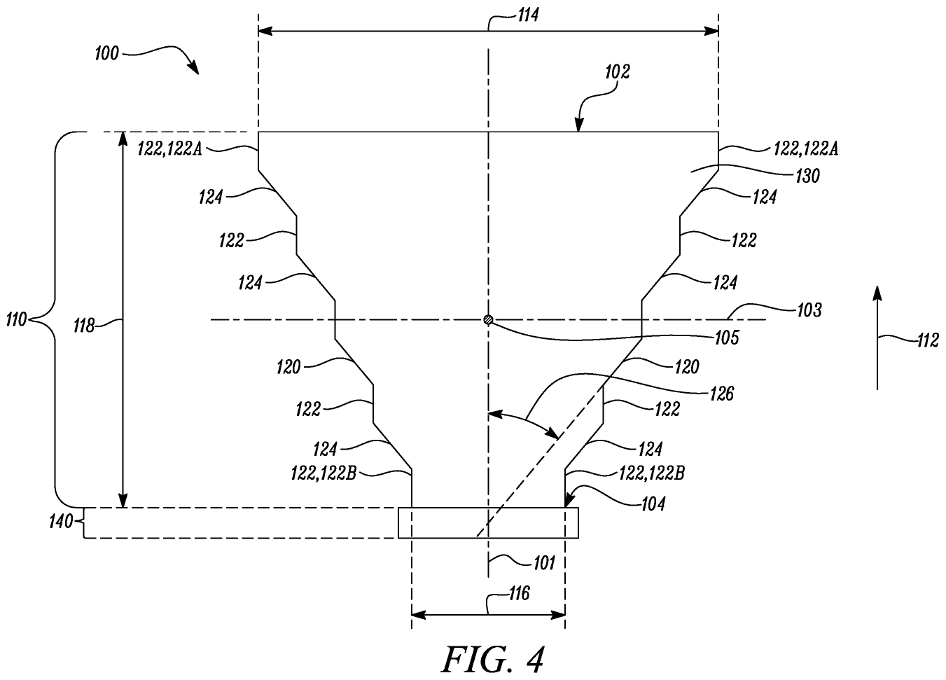

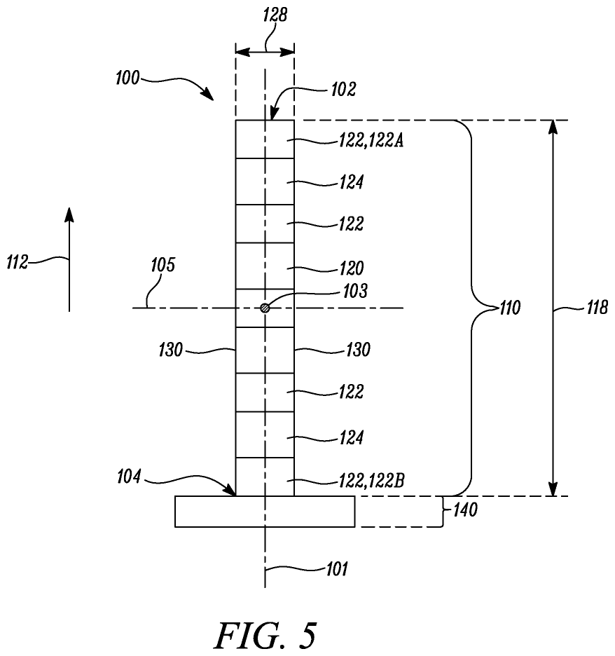

FIG. 2 illustrates a schematic sectional view of the fluid nozzle 100, according to an embodiment of the present disclosure. FIG. 3A illustrates a schematic top view of the fluid nozzle 100, according to an embodiment of the present disclosure. FIG. 3A illustrates a schematic bottom view of the fluid nozzle 100, according to an embodiment of the present disclosure. FIG. 4 illustrates a schematic front view of the fluid nozzle 100, according to an embodiment of the present disclosure. FIG. 5 illustrates a schematic side view of the fluid nozzle 100, according to an embodiment of the present disclosure.

Referring to FIGS. 1 to 5, the fluid nozzle 100 includes a body 110. The body 110 includes a first end 102 and a second end 104 opposite to the first end 102. The body 110 extends along a longitudinal axis 101 defined between the first end 102 and the second end 104. In some embodiments, the fluid nozzle 100 further includes a connecting portion 140 disposed at the second end 104 of the body 110. The connecting portion 140 is connected to the fluid source 200.

In some examples, the fluid nozzle 100 may be made from any suitable material or a combination of materials, e.g., a polymeric material (e.g., injection molded plastics), a metallic material, a ceramic material, etc. Further, the fluid nozzle 100 may be manufactured using any suitable technique or techniques, e.g., molding, 3D printing, forging, die casting, machining, stamping, vacuum forming, extrusion, etc. In some examples, the fluid nozzle 100 may be integrally formed as one-piece component. For example, the body 110 may be integral with the connecting portion 140. In some other examples, the body 110 and the connecting portion 140 may include different materials and/or may be formed as different components.

The body 110 includes an outlet 106 disposed at the first end 102 and an inlet 108 (best shown in FIG. 3B) disposed at the second end 104. The body 110 further includes a fluid passageway 111 (shown in FIG. 2) disposed within the body 110 and extending from the inlet 108 to the outlet 106. The outlet 106 includes a maximum outlet width 107 orthogonal to the longitudinal axis 101 at the first end 102. Further, the inlet 108 includes a maximum inlet width 117 orthogonal to the longitudinal axis 101 at the second end 104. The maximum outlet width 107 is greater than the maximum inlet width 117. In some embodiments, the maximum outlet width 107 is greater than the maximum inlet width 117 by a factor of at least 2. In some embodiments, the maximum outlet width 107 is greater than the maximum inlet width 117 by a factor of at least 2, at least 2.5, at least 3, at least 3.5, at least 4, at least 4.5, or at least 5.

The body 110 further includes a pair of sidewalls 120 opposing each other and extending at least along the longitudinal axis 101 from the second end 104 to the first end 102. Each of the pair of sidewalls 120 includes a plurality of first wall portions 122 and a plurality of second wall portions 124 alternating with each other.

Each first wall portion 122 from the plurality of first wall portions 122 is inclined to an adjacent second wall portion 124 from the plurality of second wall portions 124. Each of the plurality of second wall portions 124 extends outwardly relative to the longitudinal axis 101 in a flow direction 112 from the second end 104 to the first end 102, such that the body 110 tapers outwardly in the flow direction 112. The pair of sidewalls 120 at least partially defines the fluid passageway 111 therebetween.

In the illustrated embodiment, each of the pair of sidewalls 120 includes five first wall portions 122 alternating with four second wall portions 124. However, a number of the first wall portions 122 and a number of the second wall portions 124 may vary based on the application attributes. Further, in the illustrated embodiment, the first wall portions 122 have identical dimensions and the second wall portions 126 have identical dimensions. However, in some alternative embodiments, at least two first wall portions 122 may have different dimensions and at least two second wall portions 126 may have different dimensions.

Each of the plurality of first wall portions 122 extends parallel to the longitudinal axis 101. Further, each of the plurality of second wall portions 124 is inclined to the longitudinal axis 101 by an inclination angle 126. In some embodiments, the inclination angle 126 is from about 30 degrees to about 90 degrees. In some embodiments, the inclination angle 126 is about 40 degrees, about 45 degrees, about 50 degrees, about 55 degrees, about 60 degrees, or about 65 degrees. In the illustrated embodiment, the inclination angle 126 is same for the plurality of second wall portions 124. However, in some other embodiments, at least two second wall portions 124 may have different values of the inclination angle 126.

Each of the plurality of first wall portions 122 extending parallel to the longitudinal axis 101 and each of the plurality of second wall portions 124 inclined to the longitudinal axis 101 by the inclination angle 126 may allow the fluid flowing through the fluid passageway 111 more time to extrude at a desired width. In other words, the plurality of first wall portions 122 and the plurality of second wall portions 124 of the fluid nozzle 100 may reduce a rate of flow of the fluid so that the fluid nozzle 100 may provide a controlled flow of the fluid in the flow direction 112 to achieve the desired width of the fluid and prevent extending of the fluid beyond the desired width. The plurality of first wall portions 122 and the plurality of second wall portions 124 of the fluid nozzle 100 may further constrain the fluid to the desired width defined between the pair of sidewalls 120 to provide the controlled flow of the fluid in the flow direction 112. This may prevent the fluid being extruded to extend beyond the desired width by considerable distances and thus allow a controlled application of the fluid to achieve a desired appearance for replicating or accurately matching an original seam sealing.

In some embodiments, the plurality of first wall portions 122 includes a proximal first wall portion 122A extending from the first end 102 and a distal first wall portion 122B extending from the second end 104. In the illustrated embodiment of FIGS. 1 to 5, the proximal first wall portion 122A defines the outlet 106 of the body 110 and the distal first wall portion 122B defines the inlet 108 of the body 110 and is connected to the connecting portion 140 disposed at the second end 104 of the body 110. In some embodiments, the connecting portion 140 fluidly communicates with and surrounds the inlet 108 of the body 110. Specifically, the connecting portion 140 is hollow and defines a connecting passage 141 (shown in FIG. 3B) therein that fluid communicates with the inlet 108 of the body 110. The connecting passage 141 has greater dimensions than the inlet 108. In some embodiments, the proximal first wall portion 122A defining the outlet 106 of the body 110 may be based on application attributes, such as the desired width of the fluid for replicating or accurately matching the original seam sealing. Therefore, the fluid nozzle 100 includes a pair of proximal first wall portions 122A and a pair of distal wall portions 122B corresponding to the pair of sidewalls 120.

In some embodiments, the body 110 further includes a pair of longitudinal walls 130 opposite to each other and extending from the second end 104 to the first end 102. Further, each of the pair of longitudinal walls 130 extends between the pair of sidewalls 120. The pair of longitudinal walls 130 and the pair of sidewalls 120 may define the fluid passageway 111 therebetween.

In the illustrated embodiment of FIGS. 1 to 5, each of the pair of longitudinal walls 130 is planar. Further, each of the pair of sidewalls 120 has a rectangular cross-section. Therefore, in some embodiments, the fluid passageway 111 in the body 110 has a rectangular cross-section. The rectangular cross-section of the fluid passageway 111 may aid the controlled flow of the fluid in the flow direction 112 to achieve the desired appearance.

Further, in some embodiments, each of the pair of sidewalls 120 defines a thickness 128 of the body 110 orthogonal to the longitudinal axis 101. In some embodiments, the thickness 128 is constant along a length 118 of the body 110. Therefore, in some embodiments, the outlet 106 also has a rectangular cross-section.

In some embodiments, the body 110 defines a width axis 103 normal to the longitudinal axis 101 and a thickness axis 105 orthogonal to each of the width axis 103 and the longitudinal axis 101. In some embodiments, the body 110 is symmetric about each of a first plane 113 (shown in FIG. 2) including the longitudinal axis 101 and the width axis 103 and a second plane 115 (shown in FIG. 1) including the longitudinal axis 101 and the thickness axis 105. Since the body 110 is symmetric about each of the first plane 113 and the second plane 115, the fluid may have a symmetric flow within the fluid passageway 111 which may ensure the fluid being extruded has the desired appearance (i.e., having the desired width).

In some embodiments, the body 110 has a maximum width 114 orthogonal to the longitudinal axis 101 at the first end 102 and a minimum width 116 orthogonal to the longitudinal axis 101 at the second end 104. Specifically, the body 110 has the maximum width 114 along the width axis 103 at the first end 102 and the minimum width 116 along the width axis 103 at the second end 104. In some embodiments, the maximum width 114 is greater than the minimum width 116 by a factor of at least 2. In some embodiments, the maximum width 114 is greater than the minimum width 116 by a factor of at least 2.5, at least 3, at least 3.5, at least 4, at least 4.5, or at least 5. Thus, the fluid nozzle 100 may provide a wide application of the fluid to replicate the original sealing having a wide appearance.

In some embodiments, the outlet 106 includes a maximum outlet thickness 109 orthogonal to each of the maximum outlet width 107 and the longitudinal axis 101. Specifically, the outlet 106 includes the maximum outlet width 107 along the width axis 103 and the maximum outlet thickness 109 along the thickness axis 105. In some embodiments, the maximum outlet width 107 is greater than the maximum outlet thickness 109 by a factor of at least 5. In some embodiments, the maximum outlet width 107 is greater than the maximum outlet thickness 109 by a factor of at least 5.5, at least 6, at least 6.5, at least 7, at least 7.5, at least 8, at least 8.5, at least 9, at least 9.5, or at least 10. Thus, the fluid nozzle 100 may provide a flat application of the fluid to replicate the original sealing having a flat appearance.

As discussed above, the fluid system 150 shown in FIG. 1 includes the fluid source 200 connected with the fluid nozzle 100. Specifically, the fluid source 200 is disposed in fluid communication with the fluid passageway 111. Further, the connecting portion 140 is connected to the fluid source 200. The fluid nozzle 100 may dispense the fluid received from the fluid source 200. Specifically, the outlet 106 of the fluid nozzle 100 may dispense the fluid received from the fluid source 200. In some examples, the fluid source 200 may be connected to the fluid nozzle 100 through the fluid line 210. The fluid line 210 may direct the fluid from the fluid source 200 into the fluid nozzle 100. Specifically, the fluid line 210 may direct the fluid from the fluid source 200 into the inlet 108 of the fluid nozzle 100. In some embodiments, the fluid nozzle 100 is connected to the fluid line 210 via the connecting portion 140.

In the illustrated embodiment of FIG. 1, the connecting portion 140 has a square cross-section. However, the connecting portion 140 may have any suitable shape and dimensions based on application requirements. For example, the shape and dimensions of the connecting portion 140 may be based on shape and dimensions of the fluid line 210. In some embodiments, the connecting portion 140 may have a polygonal or a circular cross-section in a plane orthogonal to each of the first plane 113 and the second plane 115.

In some examples, the fluid source 200 may be directly connected to the fluid nozzle 100 (e.g., through a threaded engagement, press-fitting, quarter-turn locking mechanism, etc.) without the need for the fluid line 210. In some examples, the fluid source 200 may include any suitable fluid source or sources. In some examples, the fluid source 200 may include an associated plunger (not shown). In some examples, the plunger may be utilized to force the fluid (e.g., by applying pressure) through the fluid nozzle 100, thereby forcing the fluid through the outlet 106. In some examples, the fluid source 200 may include one or more chambers that may store one or more components of the fluid to be dispensed through the fluid nozzle 100.

In some examples, the fluid source 200 may include two chambers for storing two components. In some examples, the components from the individual chambers may be mixed before dispensing through the fluid nozzle 100. For example, a mixer (not shown) disposed between the fluid source 200 and the fluid nozzle 100 may mix the components together prior to directing the mixture of components into the inlet 108 of the fluid nozzle 100.

In some examples, the fluid from the fluid source 200 may include any suitable material or a combination of materials, e.g., seam sealers, epoxies, foams, adhesives (e.g., one or two-part adhesives), fillers, etc. Any suitable seam sealing materials may be utilized, e.g., one-part and two-part seam sealers, urethane sealers, modified saline polymer sealers, two-part epoxy sealers, one-part and two-part acrylic sealers, viscous one-part and two-part moisture sealants, UV-cure sealants, blue-light-cure sealants, heat activated sealants, etc. Further, any suitable adhesives may be utilized, e.g., one-part and two-part acrylic adhesives, etc. In some examples, the fluid may be a seam sealing composition that is adapted to seal one or more seams disposed between panels of a vehicle or a boat, or to seal seams present on interior or exterior surfaces of buildings.

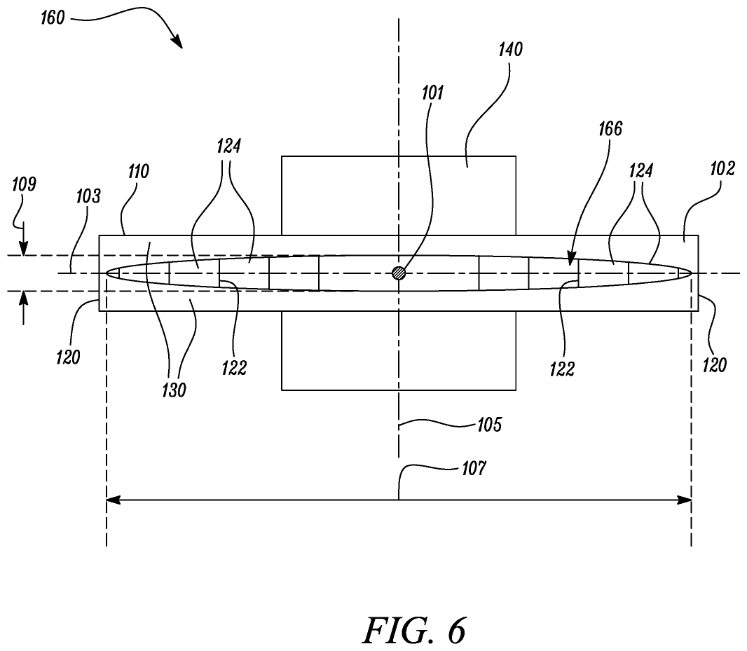

FIG. 6 illustrates a schematic top view of a fluid nozzle 160, according to another embodiment of the present disclosure. The fluid nozzle 160 is substantially similar to the fluid nozzle 100 shown in FIGS. 1-5. However, the fluid nozzle 160 an outlet 166 instead of the outlet 106 (shown in FIG. 3A). Specifically, the outlet 166 of the fluid nozzle 160 has an elliptical cross-section.

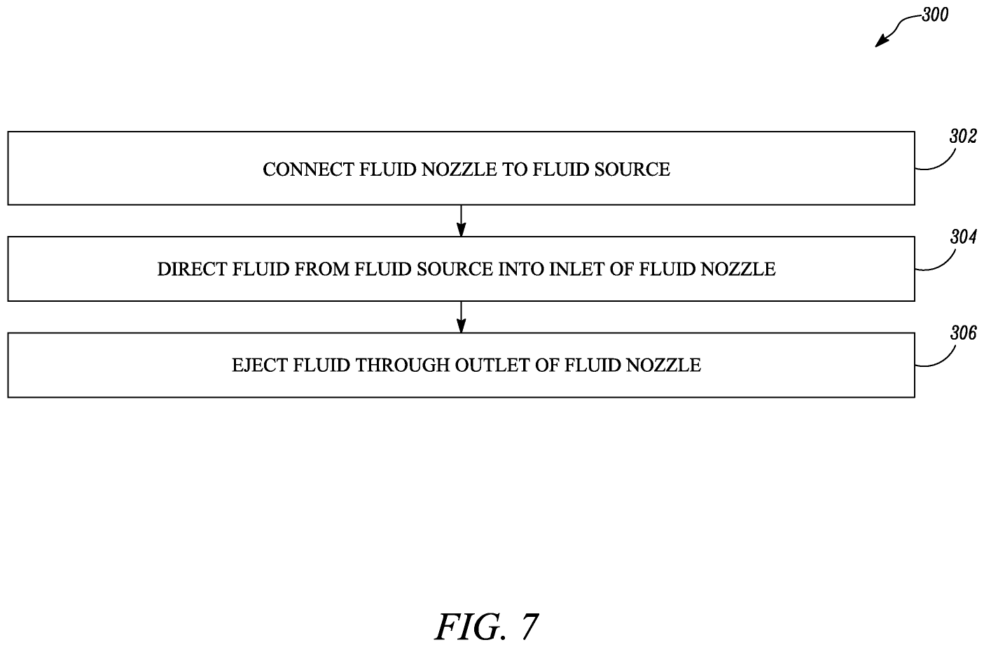

FIG. 7 illustrates a flowchart for a method 300 of using the fluid nozzle 100 (shown in FIGS. 1-5) and/or the fluid nozzle 160 (shown in FIG. 6), according to an embodiment of the present disclosure. With reference to FIGS. 1 to 6, at step 302, the method 300 includes connecting the fluid nozzle 100, 160 to the fluid source 200. At step 304, the method 300 includes directing the fluid from the fluid source 200 into the inlet 108 of the fluid nozzle 100, 160. At step 306, the method 300 includes ejecting the fluid through the outlet 106, 166 of the fluid nozzle 100, 160.

In the present detailed description of the preferred embodiments, reference is made to the accompanying drawings, which illustrate specific embodiments in which the invention may be practiced. The illustrated embodiments are not intended to be exhaustive of all embodiments according to the invention. It is to be understood that other embodiments may be utilized, and structural or logical changes may be made without departing from the scope of the present invention. The following detailed description, therefore, is not to be taken in a limiting sense, and the scope of the present invention is defined by the appended claims.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

As used in this specification and the appended claims, the singular forms “a,” “an,” and “the” encompass embodiments having plural referents, unless the content clearly dictates otherwise. As used in this specification and the appended claims, the term “or” is generally employed in its sense including “and/or” unless the content clearly dictates otherwise.

Spatially related terms, including but not limited to, “proximate,” “distal,” “lower,” “upper,” “beneath,” “below,” “above,” and “on top,” if used herein, are utilized for ease of description to describe spatial relationships of an element(s) to another. Such spatially related terms encompass different orientations of the device in use or operation in addition to the particular orientations depicted in the figures and described herein. For example, if an object depicted in the figures is turned over or flipped over, portions previously described as below or beneath other elements would then be above or on top of those other elements.

As used herein, when an element, component, or layer for example is described as forming a “coincident interface” with, or being “on,” “connected to,” “coupled with,” “stacked on” or “in contact with” another element, component, or layer, it can be directly on, directly connected to, directly coupled with, directly stacked on, in direct contact with, or intervening elements, components or layers may be on, connected, coupled or in contact with the particular element, component, or layer, for example. When an element, component, or layer for example is referred to as being “directly on,” “directly connected to,” “directly coupled with,” or “directly in contact with” another element, there are no intervening elements, components, or layers for example.

Various examples have been described. These and other examples are within the scope of the following claims.

1. A fluid nozzle comprising:
a body comprising a first end and a second end opposite to the first end, the body extending along a longitudinal axis defined between the first end and the second end, the body comprising:
an outlet disposed at the first end, wherein the outlet has a maximum outlet width orthogonal to the longitudinal axis at the first end;
an inlet disposed at the second end, wherein the inlet has a maximum inlet width orthogonal to the longitudinal axis at the second end, and wherein the maximum outlet width is greater than the maximum inlet width;
a fluid passageway disposed within the body and extending from the inlet to the outlet; and
a pair of sidewalls opposing each other and extending at least along the longitudinal axis from the second end to the first end, each of the pair of sidewalls comprising a plurality of first wall portions and a plurality of second wall portions alternating with each other, wherein each first wall portion from the plurality of first wall portions is inclined to an adjacent second wall portion from the plurality of second wall portions, wherein each of the plurality of second wall portions extends outwardly relative to the longitudinal axis in a flow direction from the second end to the first end, such that the body tapers outwardly in the flow direction, wherein each of the plurality of first wall portions extends parallel to the longitudinal axis, and wherein the plurality of first wall portions comprises a proximal first wall portion extending from the first end and a distal first wall portion extending from the second end,
wherein each of the plurality of second wall portions is inclined to the longitudinal axis by an inclination angle, the pair of sidewalls at least partially defining the fluid passageway therebetween.

2. The fluid nozzle of claim 1, wherein the inclination angle is from about 30 degrees to about 90 degrees.

3. The fluid nozzle of claim 1, wherein the body has a maximum width orthogonal to the longitudinal axis at the first end and a minimum width orthogonal to the longitudinal axis at the second end, and wherein the maximum width is greater than the minimum width by a factor of at least 2.

4. (canceled)

5. The fluid nozzle of claim 1, wherein the body further comprises a pair of longitudinal walls opposite to each other and extending from the second end to the first end, and wherein each of the pair of longitudinal walls extends between the pair of sidewalls.

6. The fluid nozzle of claim 5, wherein each of the pair of longitudinal walls is planar.

7. The fluid nozzle of claim 1, wherein the fluid passageway in the body has a rectangular cross-section.

8. The fluid nozzle of claim 1, wherein the outlet has a rectangular cross-section or an elliptical cross-section.

9. The fluid nozzle of claim 11, wherein each of the pair of sidewalls defines a thickness of the body orthogonal to the longitudinal axis, and wherein the thickness is constant along a length of the body.

10. The fluid nozzle of claim 1, wherein the body defines a width axis normal to the longitudinal axis and a thickness axis orthogonal to each of the width axis and the longitudinal axis, and wherein the body is symmetric about each of a first plane comprising the longitudinal axis and the width axis and a second plane comprising the longitudinal axis and the thickness axis.

11. The fluid nozzle of claim 1, wherein the outlet comprises a maximum outlet thickness orthogonal to each of the maximum outlet width and the longitudinal axis, and wherein the maximum outlet width is greater than the maximum outlet thickness by a factor of at least 5.

12. The fluid nozzle of claim 1, further comprising a connecting portion disposed at the second end of the body, wherein the connecting portion fluidly communicates with and surrounds the inlet of the body.

13. A method of using the fluid nozzle of claim 1, the method comprising:
connecting the fluid nozzle to a fluid source;
directing a fluid from the fluid source into the inlet of the fluid nozzle; and
ejecting the fluid through the outlet of the fluid nozzle.

14. A fluid system comprising:
a fluid nozzle comprising:
a body comprising a first end and a second end opposite to the first end, the body extending along a longitudinal axis defined between the first end and the second end, the body comprising:
an outlet disposed at the first end, wherein the outlet has a maximum outlet width orthogonal to the longitudinal axis at the first end;
an inlet disposed at the second end, wherein the inlet has a maximum inlet width orthogonal to the longitudinal axis at the second end, and wherein the maximum outlet width is greater than the maximum inlet width;
a fluid passageway disposed within the body and extending from the inlet to the outlet; and
a pair of sidewalls opposing each other and extending at least along the longitudinal axis from the second end to the first end, each of the pair of sidewalls comprising a plurality of first wall portions and a plurality of second wall portions alternating with each other, wherein each first wall portion from the plurality of first wall portions is inclined to an adjacent second wall portion from the plurality of second wall portions, wherein each of the plurality of second wall portions extends outwardly relative to the longitudinal axis in a flow direction from the second end to the first end, such that the body tapers outwardly in the flow direction, wherein each of the plurality of first wall portions extends parallel to the longitudinal axis, wherein the plurality of first wall portions comprises a proximal first wall portion extending from the first end and a distal first wall portion extending from the second end, and wherein each of the plurality of second wall portions is inclined to the longitudinal axis by an inclination angle, the pair of sidewalls at least partially defining the fluid passageway therebetween; and
a fluid source connected with the fluid nozzle and disposed in fluid communication with the fluid passageway.

15. The fluid system of claim 14, wherein the inclination angle is from about 30 degrees to about 90 degrees.

16. (canceled)

17. The fluid system of claim 14, wherein the body further comprises a pair of longitudinal walls opposite to each other and extending from the second end to the first end, and wherein each of the pair of longitudinal walls extends between the pair of sidewalls.

18. The fluid system of claim 14, wherein the outlet has a rectangular cross-section or an elliptical cross-section.

19. The fluid system of claim 14, wherein the body defines a width axis normal to the longitudinal axis and a thickness axis orthogonal to each of the width axis and the longitudinal axis, and wherein the body is symmetric about each of a first plane comprising the longitudinal axis and the width axis and a second plane comprising the longitudinal axis and the thickness axis.

20. The fluid system of claim 14, further comprising a connecting portion disposed at the second end of the body, wherein the connecting portion fluidly communicates with and surrounds the inlet of the body, and wherein the connecting portion is connected to the fluid source.
